(19) United States
(12) Patent Application Publication
(10) Pub. No.: US 2015/0272083 A1
(43) Pub. Date: Oct. 1, 2015

(54) FULLY AUTOMATIC, DOSAGE ADJUSTED FEED RECEPTACLE FOR FEEDING POULTRY

(71) Applicant: KUTLUSAN KAFES EKIPMAN VE HAYVANCILIK TASIMACILIK SANAYI TICARET LIMITED SIRKETI, Kemalpasa, Izmir (TR)

(72) Inventor: Hasan Büyükkutlu, Kemalpasa (TR)

(21) Appl. No.: 14/434,261

(22) PCT Filed: Oct. 8, 2013
(86) PCT No.: PCT/TR2013/000306

§ 371 Date: Apr. 8, 2015

(30) Foreign Application Priority Data
Oct. 8, 2012 (TR) 2012/11491

(51) Int. Cl. A01K 39/01; A01K 5/02

(52) U.S. Cl. CPC A01K 39/01; A01K 5/0275; A01K 5/0258

(57) ABSTRACT

A dosage adjusted feed receptacle enabling the feeding of the poultry in the poultry farming, including a cage system having lower rails and upper rails and being moved on the cage system, wherein it includes the following: a mixer provided with a mixing wire fixed thereon; a needle bearing housing bearing said mixer; a first gear providing rotational motion to said mixer; and a dosing unit having a spiral shaft positioned parallel thereto in the same axis below said needle bearing housing.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a dosage adjusted feed receptacle to be used in poultry farming and being capable of performing feeding of the poultry such that said feeding is performed with a weekly or a daily programming depending on the number and development level of poultry in appropriate dosages provided once or more times a day according to the different types of poultry by minimizing the feed wastage through the support of a software capable of automatically providing full precision dosage control.

In particular, the present invention relates to the following: a V groove disposed in the top portion of the feed receptacle and providing uniform distribution of the feed filled into the receptacle; stage feed hoppers with and without apertures disposed at each stage of the feed receptacle and enabling the storage of the feed at each of said stages; a pouring groove comprising a flap enabling the passage of feed between said feed hoppers; and a dosing unit driven by a dosing unit motor and enabling the feed conveyed thereto from feed hoppers to the respective poultry with desired dosage according to the commands given by the electronic unit.

2. Description of Related Art Including Information Disclosed Under 37 CFR 1.97 and 37 CFR 1.98.

Nowadays, poultry farming has gained importance due to the consumption of poultry in much greater quantities. One of the most important points in this farming is the feeding of the poultry, i.e. providing feed to the poultry. Said feeding operation is carried out manually or by feed systems being mechanically adjusted and often dosing the feed with a certain fixed setting.

One of said prior art feed systems used in feeding the poultry is the patent application numbered 2009/08687 and entitled as “An improvement in the feed systems developed for poultry”. Following is stated in the abstract of said application: “The present invention relates to an improvement in the poultry feed systems, wherein entry of the poultry into the feeders providing feed to the poultry is made harder in the poultry houses where poultry farming is carried out, said poultry cannot paw the feed even if the poultry enters therein, said poultry cannot nestle inside the feeder and said improvement enables the animals to be slaughtered to consume the feed disposed in the gizzards thereof prior to slaughtering by blocking the feed provided in the feeder”.

Another system used in the prior art for feeding of the poultry is the patent application numbered TR 2011/05758 and entitled as “An improvement in the feeder system used in poultry farming”. Following is stated in the abstract of said application: “The present invention relates to a feed plate used in the poultry farming enabling the young and adult poultry to be fed from the same receptacle and comprising a bowl provided with the feed thereon and a basket fitted on said bowl and preventing the poultry from entering into the bowl by means of the arms joining together with said bowl. Said feed plate comprises at least one separator which prevents the young poultry from entering said feed plate by closing the gap between at least one arm connected to the body thereof and arms of said basket in the case where young and adults are provided together in the poultry house and which is closed in the case of adult poultry is provided in the poultry house”.

The aforementioned feed systems have some disadvantages. One of these disadvantages is the fixed setting of the feed disposed in the feed receptacles or said setting is mechanically carried out by means of a setting apparatus. In the feeding process performed by using the feed receptacles being set as such, the feed is provided to the respective poultry at an uncertain amount referred to as an eyeball estimate. Thus, both the efficiency and quality of feeding decrease. In addition, the stability of the feed disposed in front of each compartment provided with poultry therein is also very poor.

Another disadvantage of the prior art feed systems is the requirement of same level mechanical or manual setting of the feed adjustment receptacles and apparatuses disposed at each stage provided with the respective poultry. Such adjustments are away from the simplicity. They can also be troublesome and take longer periods of time. In addition, in the adjustments performed as such, feeding cannot be fully and properly carried out as desired. Thus, growth and development levels of the poultry become different. This, in turn, results in not achieving the uniformity throughout the poultry flock. In addition, the continuous manual setting of the feed adjustment apparatuses requires additional labor and labor costs associated therewith.

Another disadvantage of the prior art feed systems is the absence of a system preventing the blockage of the feed inside the feed receptacles by compaction thereof. This, in turn, gives rise to clogging of the receptacle during feeding and thus to inefficient feeding. In addition, in said feed systems, there is no mechanism capable of minimizing the feed losses that can be experienced during feeding. In other words, there is no means to provide feed sealing in the flaps disposed between the feeding stages. This, in turn, causes an increase in the feed wastage during feeding and thus in the costs associated therewith.

Another disadvantage of the prior art feed systems is that the pouring mouth of the feed receptacle opening to the feeder is open and a portion of the feed spreads to the environment therefrom in powder form when the feed receptacle is filled. Therefore, feed wastage occurs as well as environmental pollution, thus, inconvenience in terms of health takes place.

Another disadvantage of the prior art feed systems is that the weight of the feed is not exact when feeding is desired to be performed with high volume containers, since precision dosing of the feed disposed inside the feed receptacles is not carried out. Namely, the weight of the feed provided to the animals cannot be exactly determined in the existing systems. Therefore, precisely controlled feeding cannot be performed in the existing feed systems. Further, if controlled feeding is desired to be performed in the existing feed systems, it should be carried out under human control by using containers with larger volumes instead of using the feed receptacles disposed in said systems. This requires a lot of labor and long feeding durations.

Consequently, an improvement in the relevant technical field is indispensable due to the insufficiency of the existing solutions and the need for a dosage adjusted feed receptacle to be used in poultry farming, eliminating the aforementioned disadvantages, and being capable of performing feeding of the poultry such that said feeding is performed with a weekly or a daily programming depending on the number and development level of poultry in appropriate dosages provided once or more times a day according to the different types of poultry by minimizing the feed wastage through the support of a software capable of automatically providing full precision dosage control.

### BRIEF SUMMARY OF THE INVENTION

The present invention is developed by considering the existing situations and seeks to solve the above mentioned drawbacks.

The object of the present invention is to provide means for feeding the poultry in the poultry farming such that said feeding is performed with a weekly or a daily programming depending on the number and development level of poultry in appropriate dosages provided once or more times a day according to the different types of poultry by minimizing the feed wastage through the support of a software capable of automatically providing full precision dosage control.

Another object of the present invention is to enable realizing the feeding by setting the feed weight determined for the respective poultry with a precision of ±1 g so as to provide a full dosage control thanks to the integrated electronic system and fully controlled mechanical elements of the feed receptacle.

Another object of the present invention is to enable the feed receptacle to be operated in an automatically or preferably manually controlled manner after being set and calibrated once thanks to the software control enabling continuation of the operation thereof without the need for any mechanical intervention. Thus, it is to enable the feed receptacle to be used automatically with the feed dosages that can be determined as desired and as varying for each week.

Another object of the present invention is to enable the amount of feed per hole provided in the cage provided with the respective poultry to be easily determined and thus the amount of feed given to each poultry to be followed thanks to the special spiral shafts conveying the determined volume of feed disposed on each pitch of the mixer provided in the structure of the feed receptacle.

Still another object of the present invention is to enable the feeding to be carried out with high efficiency and at desired level thanks to the determination and monitoring of the amount of feed provided by the feed receptacle and given to the poultry inside each cage. Thus, it is also to easily provide the uniformity among the characteristics of all the poultry flock being fed.

Another object of the present invention is to enable the poultry to be classified into various classes according to the uniformity of the respective poultry in each cage and to be optionally fed with different levels.

Another object of the present invention is to prevent feed wastage during the opening and closing of the flaps thanks to the flaps separating the stages disposed between the feed receptacles in the feed receptacle and to the rubber scrapers. Thus, it is to eliminate the additional costs arising from the feed wastage.

Another object of the present invention is to provide feed receptacles without a large gap opening outside like the pouring mouth and thereby to prevent the feed spreading around in powder form when feed is filled into the receptacles thanks to the structure formed in said feed receptacles. Thus, it is to save on feed as well as to prevent of environmental pollution. It is also to protect health of both humans and respective poultry.

Still another object of the present invention is to prevent blockage of the feed by compaction thereof thanks to the mixing inside the receptacle of the feed being fed by the mixer disposed inside the dosing unit of the feed receptacle. Thus, it is to increase the feeding efficiency realized with said mixing.

Another object of the present invention is to provide the optimal form of the feed so as to be consumed by the poultry by making the feed cohesively disposed inside the receptacle again fluid thanks to the mixing of the feed by the mixer disposed inside the dosing unit of the feed receptacle.

Another object of the present invention is to enable the feed filling the pitches disposed on the special spiral shafts to be scraped and to facilitate adjustment of the optimal dosage during feeding thanks to the mixer disposed inside the dosing unit of the feed receptacle.

Another object of the present invention is to prevent the respective poultry being provided with feed more than the required levels and thereby to save on feed thanks to the dosed and precise feeding provided by the feed receptacle.

The structural and the characteristic features and all advantages of the present invention will be understood more clearly with the following figures and the detailed description written by referring to said figures, therefore, the evaluation needs to be done by taking said figures and the detailed description into consideration.

### BRIEF DESCRIPTION OF THE DRAWINGS

The embodiment of the present invention and advantages thereof with the additional components must be considered together with the figures explained below in order to be fully understood.

FIG. 1: A perspective front view of the dosage adjusted feed receptacle according to the present invention in stages.

FIG. 2: A two dimensional front view of the dosage adjusted feed receptacle according to the present invention in stages.

FIG. 3: A two dimensional cross sectional side view of the dosage adjusted feed receptacle according to the present invention in stages.

FIG. 4: A perspective front view of the dosing unit of the dosage adjusted feed receptacle according to the present invention.

FIG. 5: A perspective rear view of the dosing unit of the dosage adjusted feed receptacle according to the present invention.

FIG. 6: A disassembled perspective front view of the dosing unit of the dosage adjusted feed receptacle according to the present invention.

FIG. 7: A perspective view of the poultry farming cage system provided with the dosage adjusted feed receptacle according to the present invention therein.

### REFERENCE NUMBERS USED IN THE FIGS

100—Dosage adjusted feed receptacle
110—Dosing unit
111—Spiral shaft
112—Spiral pipe
113—Dosing unit back plate
114—Dosing unit front plate
115—Dosing unit body plate
116—Rear bearing housing
117—Front bearing housing
118—Bearing I
119—Bearing II
120—Dosing unit connector mount
121—Dosing unit centering shaft
122—Dosing unit fixing shaft
123—Dosing unit front group fixing shaft
124—Guiding plate spacer bushing
125—Guiding plate
126—Guiding plate cover
127—Central bolt
128—Small bolt
129—Large bolt
130—Small outer ring
131—Large outer ring
132—Central outer ring
133—Nut
134—Bolt I
135—Bolt II
136—Bolt III
137—Bolt IV
138—Mixer
139—Needle bearing
140—Needle bearing housing
141—Front cover washer
142—Second gear
143—Front guard plate
144—Front guard support plate
145—First gear
146—Wedge I
147—Wedge II
148—Wedge III
149—Mixing wire
150—Stage feed hopper without aperture
160—Stage feed hopper with aperture
170—Pouring groove
180—Pouring groove flap
190—Hopper inner cover
200—Hopper side cover
210—Hopper side cover handle
220—Dosing unit motor
230—V groove
240—Wheel
250—Leg
260—Leg lower bracket
270—Connection plate
280—Rear cross bracket
290—Side cross bracket
300—Dosing unit front support plate
310—Wheel U profile
320—Electronic unit
400—Feed car
500—Lower rail
600—Upper rail
700—Cage system
800—Main control panel

### DETAILED DESCRIPTION OF THE INVENTION

In this detailed description, dosage adjusted feed receptacle (100) according to the present invention is described for a better understanding of the subject without constituting any restrictive effect.

Accordingly, the present invention comprises the following: wheels (240) connected to the feed receptacle (100) by means of the U profile connection plate and U profile (270, 310) and enabling the movement of the receptacle (100) along the cage system (700); legs (250) with lower, side, and rear cross brackets (260, 280, 290) enabling the feed receptacle (100) to be securely disposed on said wheels (240); a V groove (230) disposed in the top portion of the receptacle (100) and enabling the feed to be filled into the receptacle and evenly distributed; a stage feed hopper without aperture (150) disposed at the bottom stage of the feed receptacle (100) and enabling the storage of the feed provided at this stage; stage feed hoppers with apertures (160) disposed at the other stages of the feed receptacle (100) and enabling the storage of the feed at these stages; a pouring groove (170) comprising a flap (180) enabling feed passage between said feed hoppers (150, 160); and a dosing unit (110) driven by the dosing unit motor (220), disposed at each stage of the feed receptacle (100) and enabling the feed conveyed thereto by the feed hoppers (150, 160) to be conveyed to the respective poultry with the desired dosage by moving together with the electronic unit (320) interacting therewith.

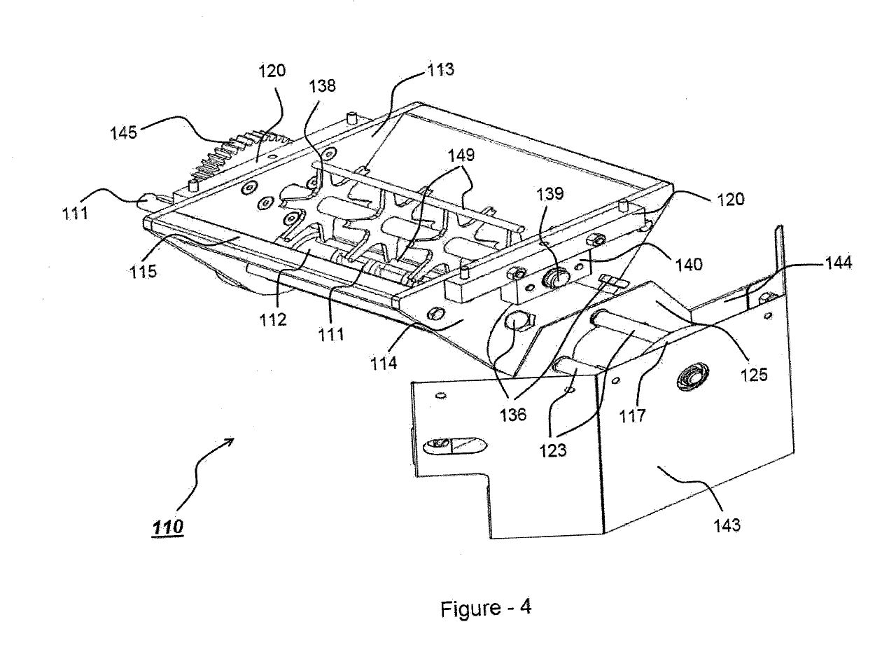

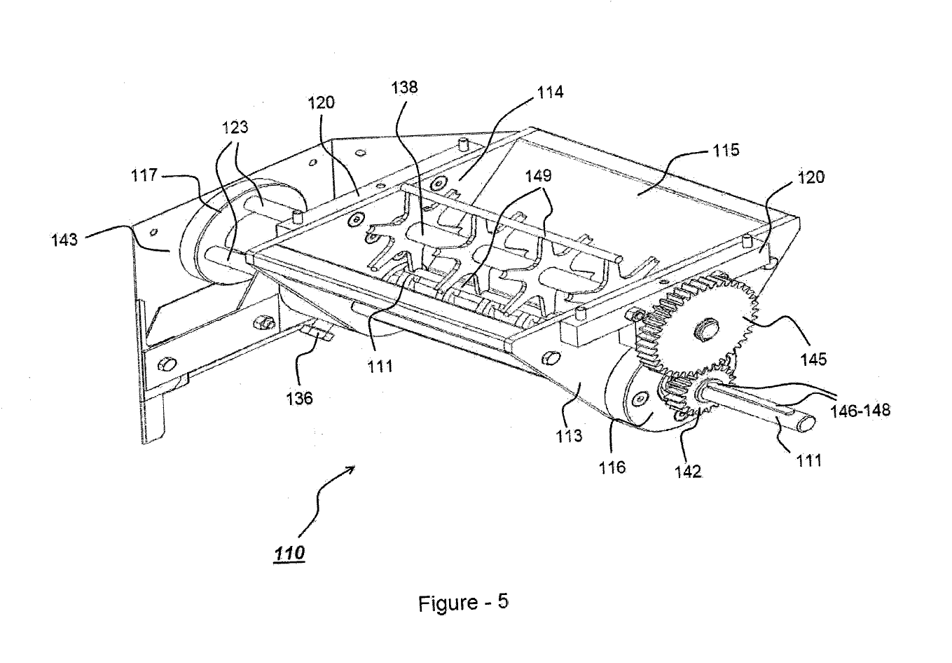

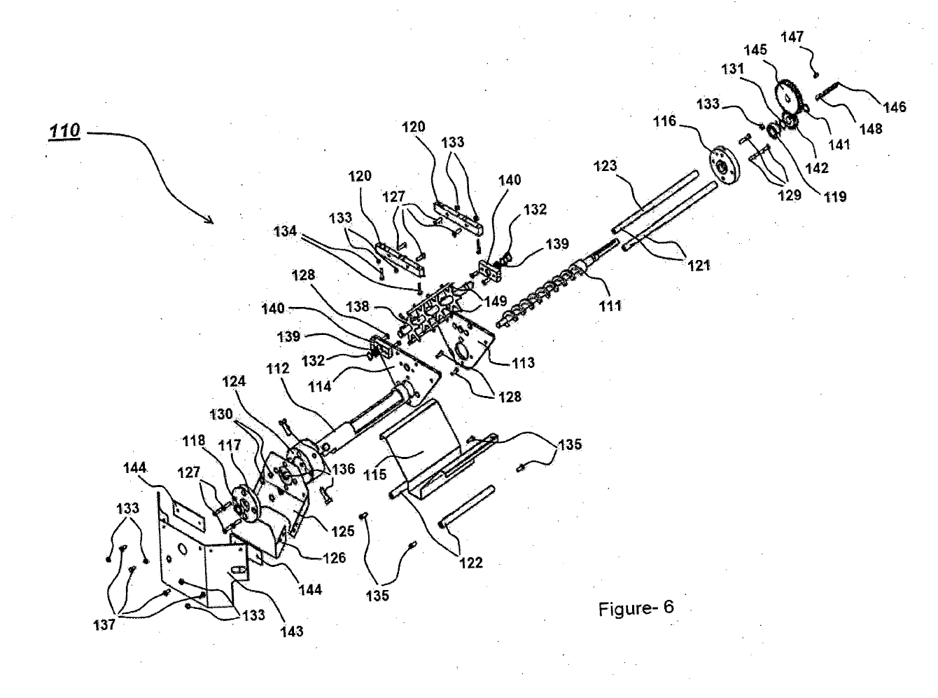

The dosing unit (110) is the most important element of the dosage adjusted feed receptacle according to the present invention. In FIGS. 4, 5, and 6, front and rear perspective, disassembled views of the dosing unit (110) of the dosage adjusted feed receptacle (100) according to the present invention are given. Said dosing unit (110) serves for automatically feeding the feed conveyed thereto by the hoppers according to the commands received from the electronic unit (320) interacting therewith at predetermined and programmed dosages to the front portion of the cage of the respective poultry.

Elements of said dosing unit (110), functions and mounting thereof are as follows: The body plate (115) is designed so as to concentrate the feed coming from the feed receptacle (100) onto the inner portion of the spiral pipe (112). The geometry of the lower portion of said body (115) is provided with a structure so as to center the spiral pipe (112) with 3 linear contacts, i.e. lower, right, and left contacts. The mixer (138) is disposed as mounted with the special spiral shaft (111) and pipe (112) inside this dosing unit body plate (115). The exposed portions this element is enclosed by the front and rear plates (123, 124) of the dosing unit. The function of said plates (113, 114) is to enclose the exposed portions of the body plate (115) as well as to form mounting surface for mounting of the pieces connected to the dosing unit (110) of the feed receptacle (100).

Special spiral shaft and spiral pipe (111, 112) are mounted on said front and rear plates (114, 113). In this mounting, an end of the special spiral shaft (111) is embedded in the bearing II (119) disposed inside the rear bearing housing (116) on the rear plate (113) and the other end thereof is embedded in the bearing I (118) disposed inside the front bearing housing (117) on the front plate (114). The special spiral shaft (111) serves for advancing the feed coming from the feed receptacle (100) to the pouring mouth of the spiral pipe (112). This shaft (111) is precisely manufactured by machining with a special geometry enabling the feed to be distributed according to the rotational speed. The spiral pipe (112) is mounted in the lower portion of the dosing unit body plate (115) with a special spiral shaft (111) disposed therein. The function thereof is to guide the feed being poured down from the feed receptacle (100) into the pipe. This pipe (112) is coaxially mounted with the spiral shaft (111), wherein it enables the feed to be evenly poured and not jammed therein. Said pipe (112) is manufactured with suitable geometry so as perform the function thereof.

The dosing unit connector mount (120) enable the dosing unit (110) to be mounted to the feed receptacle (100). The dosing unit centering shaft (121) centers the dosing unit front plate and the rear plate (114, 113) for proper mounting of the spiral pipe (112) and the mixer (138). The dosing unit fixing shaft (122) is the element limiting the rotational degrees of freedom of the dosing unit front and rear plates (114, 113) relative to each other in the axis of the spiral shaft (111). The dosing unit front group fixing shaft (123) enables the connection and mounting of the front group elements. Feed guiding plate spacer bushing (124) keeps the feed guiding plate (125) at an appropriate distance relative to the feed pouring mouth of the spiral pipe (112). In addition, when it is circumferentially tightened with four bolts III (136), it limits the rotational degrees of freedom of the spiral pipe (112). The feed guiding plate (125) enables the most appropriate distribution of the feed coming from the pouring mouth of the spiral pipe (112) on the cage feeder. Said plate (125) is mounted with the most appropriate angle and geometry for performing said function. The cover (126) of said guiding plate (125) serves for accelerated advancing the feed poured on the guiding plate (125) and preventing spreading thereof to the right and left. This cover (126) also helps the feed to fall onto the appropriate location inside the feeder. In addition, it also supports the front guard plate (143).

The mixer (138) is an improvement provided by the dosage adjusted feed receptacle (100) according to the present invention. It is mounted so as to be disposed just above the special spiral shaft (111) and pipe (112) between said mixer (138) and the dosing unit front and rear plates (114, 113). Both ends of the mixer (138) are embedded to said plates (114, 113) in the needle bearing (139) disposed inside the needle bearing housing (140). The mixer (138) can be rotated around the axis thereof thanks to this housing and bearing (140, 139). Small bolts (128) are used for mounting said housing (140) to the respective plates (114, 113). The mixer (138) serves for enabling adjustment of the feed dosage by providing scraping of the feed filling onto the spiral shaft (111) during feeding and for incorporating the agglomerated and jammed feed into the feeding process by releasing the feed inside the dosing unit (110).

The first gear (145) is connected from outside to the end of the shaft of the mixer (138), wherein it is connected to the second gear (142) from the lower portion. The second gear (142) is connected from outside to the special spiral shaft (111). Here, the movement is transmitted from the dosing unit motor (220) to the special spiral shaft (111). Upon rotation of said shaft (111), the second gear (142) connected to the shaft, and thus, the first gear (145) start to rotate. The front guard plate (143) of the dosing unit is disposed at the front of the dosing unit (110), wherein it is an element with special geometry developed for preventing the damage of the elements of the dosing unit (110) to respective poultry being fed. The dosing unit front guard support plate (144) connects the front guard plate (143) to the feed guiding plate (125).

The connection elements used in the connection of the elements of the dosing unit (110) described above and functions thereof are as follows: the central bolt (127) is used for connecting the dosing unit connector mount (120) and the front bearing housing (117). The small bolt (128) enables the connection of the rear bearing housing (116), needle bearing housing (140) and the dosing unit front group fixing shaft (123). The large bolt (129) enables the connection of the rear bearing housing (116). The small outer ring (130) is used for fixing the feed guiding plate (125) and positioning the special spiral shaft (111). The large ring (131) positions the special spiral shaft (111) and the second gear (142) connected to said shaft (111). The central ring (132) positions the mixer (138) shaft and the first gear (145) connected to said shaft. The nut (133) is used in the connection of various dosing unit (110) elements.

The bolt I (134) is used for connecting the dosing unit connector mount (120) to the feed receptacle (100). The bolt II (135) connects the dosing unit fixing shaft (122) to the dosing unit front and rear plates (114, 113). The bolt III (136) enables the rotational degrees of freedom of the spiral pipe (112) to be limited on the feed guiding plate spacer bushing (124). The bolt IV (137) is used for connecting the front guard support plate (144) to the front guard plate (143) and the feed guiding plate (125). The threaded cover washer (141) limits the position of the second gear (142) connected to the special spiral shaft (111). The wedge I (146) is the element placed for driving of the special spiral shaft (111) by the dosing unit motor (220). The wedge II (147) provides driving of the mixer (138) by the first gear (145). The wedge III (148) enables the second gear (142) to be driven by the spiral shaft (111).

Mounting and operating principle of the dosing unit (110), provided above with the elements thereof, functions and locations of said elements, is as follows:

The dosing unit front plate (114) and the dosing unit rear plate (113) are connected to each other by means of the dosing unit centering shafts (121), dosing unit fixing shafts (122) and dosing unit front group fixing shaft (123) such that the dosing unit front plate (114) and dosing unit rear plate (113) and spiral pipe (112) holes are aligned to be completely parallel and coaxial with limited rotational degrees of freedom. The body plate (115) is brought to the appropriate position by enabling the linear contact of the half square flat plate profile disposed in the lower portion of the dosing unit body plate (115) disposed between the dosing unit front plate (114) and the dosing unit rear plate (113) to the lower, right and left portions of the spiral pipe (112). When the body plate (115) is located in the appropriate position, the feed disposed inside the dosing unit (110) is enabled to advance through the spiral pipe (112) and prevented from going to dead spots. Thus, degradation of the feed, potential development of diseases in the respective poultry and wastage of said feed is prevented. The special spiral shaft (111) advances the feed received from the dosing unit (110) by rotating inside the spiral pipe (112) towards the pouring mouth of the spiral pipe (112). The special spiral shaft (111) is completely manufactured as a single piece by machining from the solid shaft. Thus, it is more durable than the normally used spiral shaft (111) and it has a smaller shaft cylindrical misalignment. The pitches comprised in the structure of the special spiral shaft (111) are equally spaced with equal depths thanks to such manufacturing. The amount of feed filling into the pitches of the special spiral shaft (111) is continuously identical since all the pitches thereof are manufactured with equal and low obliqueness and nothing to cause narrowing of the pitches is disposed therein. The feed advanced as such is suitable for the stable and precise feed dosages. Another feature of the special spiral shaft (111) is the prevention of the differences between the pitches by elimination of the feed filling the corners in some pitches thanks to the radius of the bottom part of the spiral. In order to avoid jamming of the feed between the special spiral shaft (111) and the spiral pipe (112), the surface of the special spiral shaft (111) is polished by means of a method such as mopping, sanding or grinding. The special spiral shaft (111) is embedded in the bearing II (119) disposed inside the rear bearing housing (116) and in the bearing I (118) disposed inside the front bearing housing (117) provided on the dosing unit front and rear plates (114, 113). Said shaft (111) is driven by the dosing unit motor (220) through the wedge (146).

The feed inlet mouth angle of the spiral pipe (112) is parallel to the angles of the side surfaces of the dosing unit body plate (115) extending from the upper portion towards the lower portion thereof. Thus, the feed is prevented from going to the dead spots inside the dosing unit body plate (115). The feed going to the dead spots results in unfavorable situations such as degradation thereof, the poultry to get sick and decrease of feed utilization. The mixer (138) is embedded between the two needle bearing housings (140).

The gear ratio of the first gear (145) connected to the mixer (138) shaft to the second gear (142) is 2:1. Namely, in each turn of the special spiral shaft (111), the mixer (138) rotates half a turn in the opposite direction. 2 mixing wires (149) are peripherally disposed in the mixer (138). Thus, in each turn of the special spiral shaft (111), the mixing wire (149) of the mixer (138) passes once over the special spiral shaft (111) and forces the feed into the spiral pitch. Another function of the mixer (138) is to fluidize the agglomerations inside the feed and the feed jammed inside the stage feed hoppers (150, 160) and to enable the filling thereof into the dosing unit (110). The star shaped pieces disposed in the mixer (138) are developed to prevent feed agglomerations and to enable fluidity of the feed.

Feed guiding plate spacer bushing (124) is used for stopping the feed guiding plate (125) at the appropriate distance. Said bushing comprises 4 circumferential bolt holes to be connected with the bolt III (136) for limiting the rotational degrees of freedom of the spiral pipe (112) in the pipe axis. The feed guiding plate (125) is developed for appropriately pouring the feed into the feeder through the pouring mouth of the spiral pipe (112). The feed guiding plate cover (126) is connected to the front of the feed guiding plate (125). The feed guiding plate cover (126) also supports the dosing unit front guard plate (143). The dosing unit front guard plate (143) immediately pushes the poultry back into the cage by means of the two surfaces having an angle of 45° disposed on both sides thereof for preventing the poultry to interfere with the feed receptacle. The front upper guard plate (300) of the dosing unit supports the dosing unit front guard plate (143) and protects the elements connected to the dosing unit (110). In addition, self-injury of the poultry by means of any involvement thereof is also avoided.

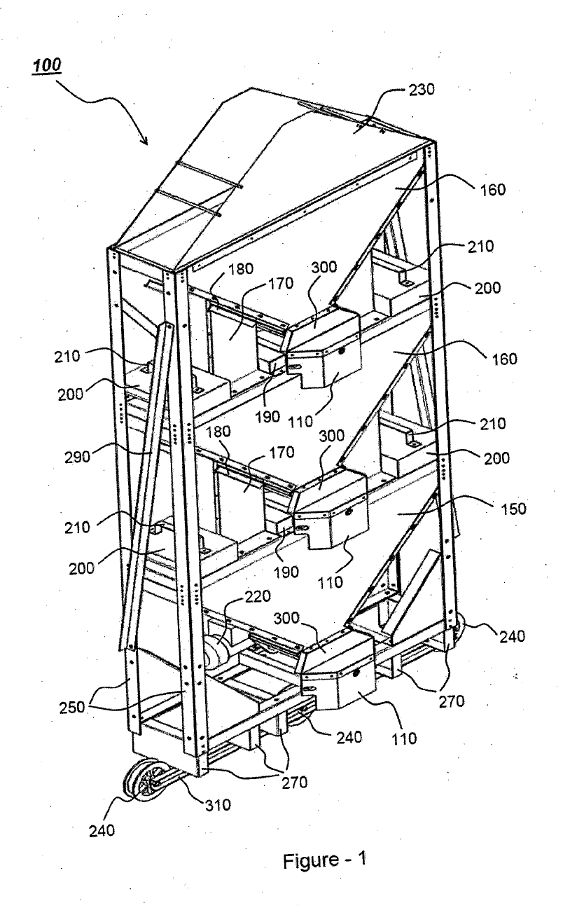

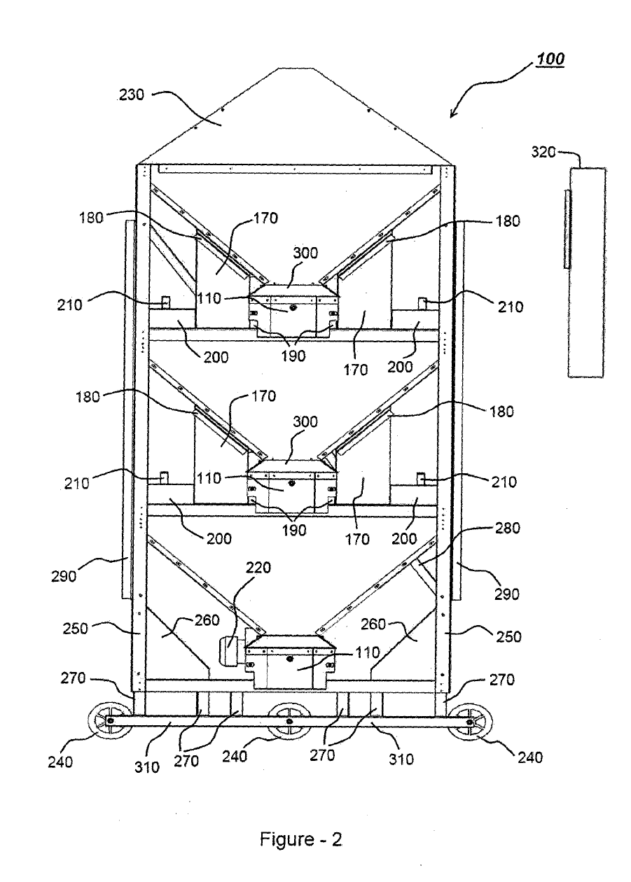

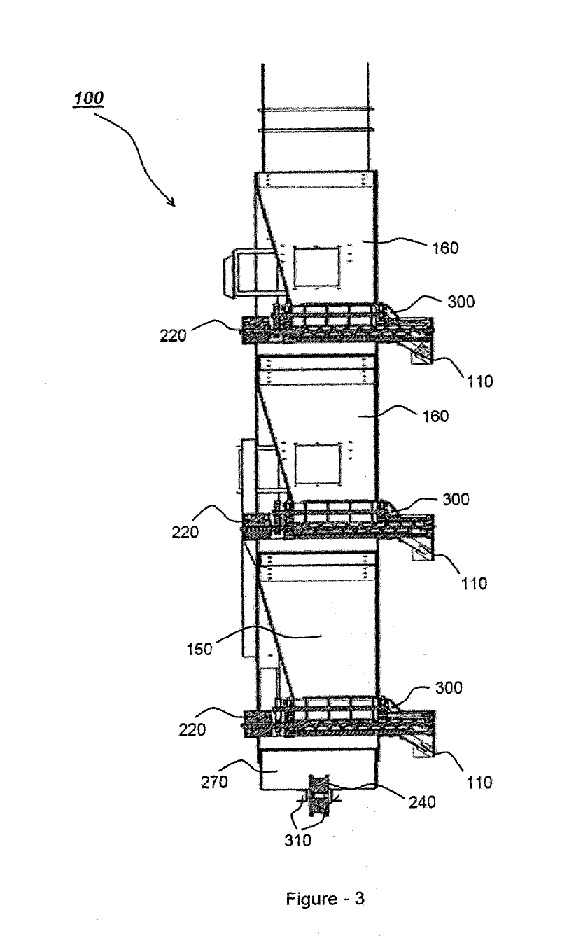

In FIGS. 1, 2, and 3, perspective front and two dimensional front and side views of the dosage adjusted feed receptacle (100) according to the present invention in stages are given, respectively. According to said figures:

The stage feed hopper without aperture (150) is disposed at the bottom stage of the feed receptacle (100). The function thereof is to enable storage of the feed of the respective stage and conveying the feed to the dosing unit (110) when required. The stage feed hopper with aperture (160) is disposed at the other stages of the feed receptacle (100) other than the bottom stage thereof. The function of said hopper (160) is also to enable storage of the feed of the respective stage and conveying the feed to the dosing unit (110) when required. Said two hoppers (150, 160) are also made of sheet metal.

The amount of the feed filling into said hoppers (150, 160), including the amount of feed disposed in the V groove (230) and pouring grooves (170), is designed so as to be 65 kg on average depending on the characteristics of the feed. Thus, the feed receptacle (100) according to the present invention is in accordance with the majority of the poultry houses available in the world and provided with a dosage having a certain degree of safety margin. The pouring groove (170) is used for transferring the feed from the aperture of the stage feed hopper with aperture (160) to the feed hopper disposed on a lower stage. Said groove (170) is mounted so as to be disposed between two stages depending on the number of stages of the feed receptacle (100). A pouring groove flap (180) is disposed inside the pouring groove (170). Said flap (180) is opened when the feed receptacle (100) is to be filled with the feed. After the receptacle (100) is filled, the flap is closed. Thus, the stage feed hoppers (150, 160) are completely separated from each other and maximum benefit from the feed is obtained by using said flap for transferring the entire feed provided in each of the stage feed hoppers (150, 160) to the respective stage. Scrapers mounted to the pouring groove (170) are disposed at the front and rear of the pouring groove flap (180). Feed wastage is prevented during the opening and closing of the flap (180) thanks to these scrapers.

The hopper inner and side covers (190, 200) prevent the diffusion and spreading of the feed provided inside the hoppers to the air by closing the inner and side gaps of the respective hoppers. The hopper side cover handle (210) is used for easy mounting and removal of the hopper side cover (200). The hopper side cover (200) is an element that can be mounted and removed by means of the hopper side cover handle (210). Control, monitoring and routine cleaning of the interior portion of the feed receptacle (100) can be performed by opening the hopper side cover (200). The feed receptacle (100) according to the present invention minimizes the feed wastage and becomes an environmentally friendly receptacle thanks to these covers (190, 200), rubber scrapers and spiral shaped outlet of the pouring mouth of the feed receptacle (100). The dosing unit motor (220) is a gear motor, wherein it rotates the special spiral shaft (111) connected to the dosing unit (110), thus, the moving elements disposed inside the dosing unit (110). This motor (220) adjusts the appropriate feed dosages by rotating at variable speeds according to the output frequency of the speed control drive disposed in the electronic unit (320). The V groove (230) is used in the upper portion of the feed receptacle (100) for appropriate distribution of the feed inside said receptacle. The wheels (240) are used for moving the feed receptacle (100) on a lower rail (500) along the respective cage system (700). The feed receptacle (100) is guided in two different ways to the feed car (400) moving on the lower rail (500) in the lower portion and on the upper rail (600) of the cage system (700) in the upper portion. Thus, the balance of the receptacle (100) is tuned in the most appropriate manner and distribution of the load is balanced. This condition minimizes the potential accidents such as crashing, rubbing of receptacle (100) against the cage system (700), prevents, and avoids the poultry provided inside the cage system (700) and the cage to be damaged.

The legs (250) are the elements connected with the feed receptacle hoppers (150, 160), lower wheels (240), horizontal cross members and brackets. The leg lower bracket (260) enables appropriate distribution of the load and the upright position of the legs (250), when said legs (250) are connected to the lower wheels (240). The wheel U profile connection plate (270) is employed for the mounting of the wheel U profile (310) to the feed receptacle (100). Rear and side cross brackets (280, 290) are disposed on four sides of the feed receptacle (100) and provide balancing thereof in the horizontal and vertical axes. The wheel U profile (310) enables the wheels (240) to be connected to the feed receptacle (100).

The electronic unit (310) adjusts the speed of said motor (220) according to the dosing data stored therein by working interactively with the dosing unit motor (220). The amount of feed with desired dosage is provided to the respective poultry with full precision as a result of this adjustment, thus, as a result of the desired operation of the motor (220), thus, the special spiral shaft (111) and the mixer (138) connected thereto.

Operating principle of said electronic unit is as follows:

The feed receptacle (100) is provided with a dosing unit motor (220) at each stage. Two dosage adjusted feed receptacles (100) and a feed car (400) are disposed in one row. The dosage-adjusted feed receptacles (100) are mounted to the feed car (400). The electronic unit (320) is disposed on the feed receptacles (100) provided in each cage row. Speed control drivers are disposed in the electronic unit (320) for adjusting the speed of the dosing unit motors (220). If motors (220) to be provided with different speeds exist, the number of these speed control drivers can be increased according to the number of motors to be provided with different speeds. Following are provided for communicating with the main control panel disposed on the electronic unit (320): a programmable logic controller (PLC), a wireless network client (Access point client), a wireless network antenna and motor thermals for the safety of the special spiral shaft (111) and the dosing unit motor (220). Following are disposed on the main control panel (800) for communicating with the electronic units: a programmable logic controller (PLC), a wireless network server (Access Point), a wireless network antenna, a touch screen for data input, and switches providing the commands of the feed cars (400) and the hopper spirals. The programmable logic controller (PLC) disposed in the main control panel (800) is the controller where the program of the feed system is installed.

The program works as follows:
1—The initial date and flock entry date is set in the program.
2—Desired amount of feed corresponding to the weeks is entered into the weekly feed program.
3—A row to be calibrated is selected.
4—Motor speed is set as 100% in the program such that the dosing unit motors (220) operate at 50 Hertz.
5—Upon operation of the dosing unit motors (220), the feed car (400) motors are also operated and advancing thereof towards the feed receptacle (100) is enabled.
6—The feed poured into a unit is collected by any method and total weight of said feed is measured.
7—The feed poured into a unit is divided by the number of poultry and the result is entered into the system as the calibration value.
8—According to the weekly amount of the feed suitable for the flock age calculated by the difference between the entry date of the flock and the system date, the Hertz values of the motors are automatically calculated according to the calibration provided in the program using the mathematical proportions and if desired, the system is operated automatically or manually until the flock leaves said system.
9—If there is a problem of uniformity within the flock, the feeding program can be continued by adjusting the dosing unit motors (220) of each row to a different weight in order to overcome this problem.

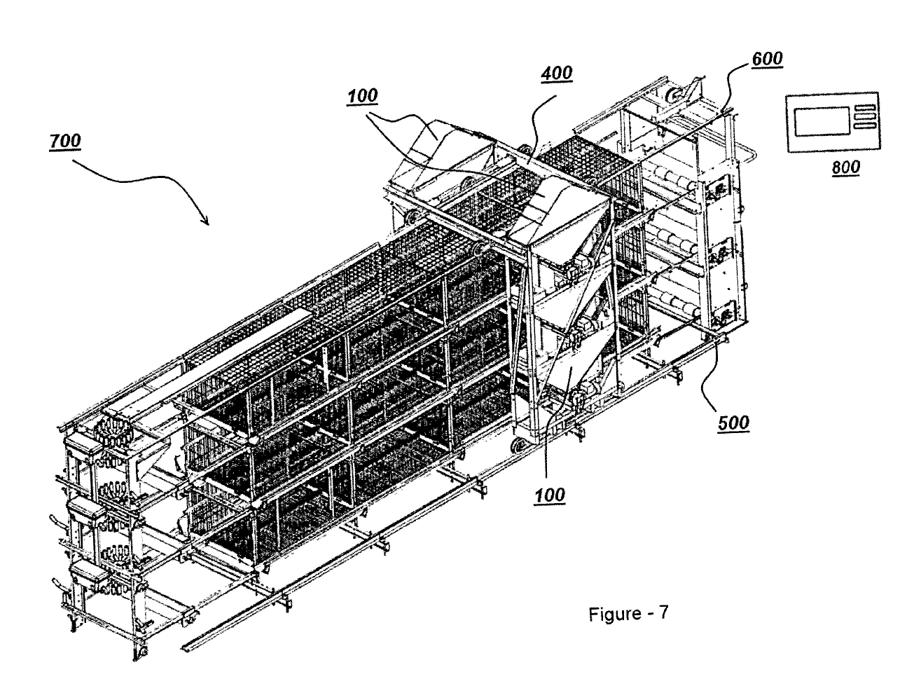

In FIG. 7, a perspective view of the cage system provided therein with the dosage adjusted feed receptacle (100) according to the present invention described above with the elements thereof, the functions and operating principles of said elements is illustrated.

According to said figure:

The dosage adjusted feed receptacle (100) performs the distribution of the feed inside the cage system (700) by setting the required dosage.

The feed car (400) enables the dosage adjusted feed receptacle (100) to move forward and backward with a constant speed and direction along the cage.

The lower rail (500) guides the wheels (240) disposed in the lower portion of the dosage adjusted feed receptacle (100) and enables the feed receptacle (100) to smoothly move along the cage system (700) at a suitable uprightness.

The upper rail (600) guides the feed car (400) connected to the dosage adjusted feed receptacle (100) from the upper portion and enables smooth movement of the feed car (400), thus, the feed receptacle (100) connected thereto on the cage system (700).

The dosage adjusted feed receptacle according to the present invention comprises elements and features that can be different from the ones mentioned above. Said elements and features are as follows:

The mixer (138) can be comprised of one or more horizontal mixing wires (149) and/or one or more star shaped mixers. The mixing wire can have a diameter smaller or larger than Ø 5.8. The mixer (138) can be formed with a geometry consisting of one or more circumferential mixing arms.

Instead of the mixer (138), right or left hand spiral rotating in the opposite direction can also be used. The pitch and diameter of the employed spiral can be smaller or larger than the pitch and diameter of the special spiral shaft (111).

The mixer (138) can be used for this purpose by being manufactured with a different system, geometry and special design. The mixer (138), instead of working parallel to the spiral, can be operated by being embedded perpendicularly or at an angle. Apart from these, a vibration ball of any diameter disposed freely therein can be used.

The gear ration between the mixer (138) and the spiral shaft (111) can be set to a smaller or larger value. The dosing system disposed in the feed receptacle (100) can also be operated with or without mixer and with or without vibration ball.

Instead of the special spiral shaft (111), this system can be formed by welding a normal shaft and a standard spiral together. The diameter and the pitch of the special spiral shaft (111) or the normal shaft can be smaller or larger. The special spiral shaft (111) or the shaft welded thereon with a spiral can also be manufactured from the other types of steel other than the leaded free cutting steel.

Manufacturing of the pieces, singly or in combination, disposed in the special spiral shaft (111) and the dosing unit (110) can be performed by means of gray iron (pig) casting, ductile iron casting, aluminum die casting, powder metallurgy, plastic injection molding, deep drawing, plastic centrifuge, precision casting, or direct machining of solid materials.

The feed car (400) can comprise one or more wheels (240).

The stage feed hopper without aperture (150) and the stage feed hopper with aperture (160) can be arranged with an internal volume to contain a feed amount less or more than 65 kg. The dosing unit motor (220), instead of a gear motor, can be any type of motor such as a stepper, servo, planetary gear motor or the like.

The dosing process can also be applied using a load cell.

The dosing process can also be performed by developing a system automatically filling the feed into certain pitches and pouring said feed of certain pitches to the feeder as a mechanical solution for the high volume containers.

The dosing process can also be carried out by the volumetrically opening flaps controlling the fluidity of the feed.

The present invention is developed for broiler, breeder hens, wherein it can be used in the poultry cages of the young and adult layer, breeder and broiler poultry.

The present invention, providing successful solutions to the aforementioned technical problems and to be widely employed in the respective fields, relates to a dosage adjusted feed receptacle (100) to be used in poultry farming and being capable of performing feeding of the respective poultry such that said feeding is performed with a weekly or a daily programming depending on the number and development level of poultry by minimizing the feed wastage through the support of a software capable of automatically providing full precision dosage control.

1. A dosage adjusted feed receptacle enabling the feeding of the poultry in the poultry farming, comprising a cage system having lower rails and upper rails and being moved on said cage system, characterized in comprising the following: a mixer provided with a mixing wire fixed thereon; a needle bearing housing bearing said mixer; a first gear providing rotational motion to said mixer; a dosing unit having a spiral shaft positioned parallel thereto in the same axis below said needle bearing housing, which is placed at each storey of the cage system, connected to dosing unit motor which can operate in changing speeds according to the commands received from the electronic unit which communicates with the main control panel, wherein the feed system program is loaded, via a wireless network which has a programmable logic controller (PLC).

2. The feed receptacle according to claim 1, characterized in comprising; a second gear connected to both of said spiral shaft and said first gear.

3. The feed receptacle according to claim 2, characterized in comprising; dosing unit front group fixing shafts secured by means of a front bearing housing.

4. The feed receptacle according to claim 1, characterized in comprising; a dosing unit front plate and a dosing unit rear plate enclosing said mixer and spiral shaft.

5. The feed receptacle according to claim 1, characterized in comprising; a dosing unit body plate secured from its lateral portions by means of said dosing unit front plate and dosing unit rear plate.

6. The feed receptacle according to claim 1, characterized in comprising; a dosing unit connector mount fixed on said dosing unit body plate.

7. The feed receptacle according to claim 1, characterized in comprising; a front guard plate secured with said front bearing housing.

8. The feed receptacle according to claim 1, characterized in comprising; a spiral pipe for positioning of said spiral shaft therein.

9. The feed receptacle according to claim 1, characterized in comprising; a dosing unit centering shaft and dosing unit front group fixing shaft enabling connection of the front group pieces of said dosing unit.

10. The feed receptacle according to claim 1, characterized in comprising; a rear bearing housing embedded with said spiral shaft.
